(19) United States
(12) Patent Application Publication
(10) Pub. No.: US 2025/0390929 A1
(43) Pub. Date: Dec. 25, 2025

(54) Personalized Recommendations Matching a List of Item Descriptors to Catalog Products from a Database

(71) Applicant: Maplebear Inc., San Francisco, CA (US)

(72) Inventor: Naval Shah, Toronto (CA)

(21) Appl. No.: 18/753,920

(22) Filed: Jun. 25, 2024

(51) Int. Cl. G06Q 30/0601; G06Q 30/0201

(52) U.S. Cl. CPC G06Q 30/0631; G06Q 30/0201; G06Q 30/0633; G06Q 30/0643; G06Q 30/0603

(57) ABSTRACT

Personalized recommendations matching a list of item descriptors to catalog products from is described. A list associated with a user is received that includes item descriptors. The item descriptors correspond to catalog products stored in a catalog database that includes a plurality of catalog products. Linking data for the user is retrieved. For at least one of the item descriptors in the list, a model is applied to the linking data to generate a score for each of a set of candidate catalog products. A list of recommended catalog products for the user is built by, for each of the item descriptors in the list, selecting one of the set of candidate catalog products based on the generated scores. The list of recommended catalog products is provided to a user client device associated with the user. The user client device is configured to display the list of recommended catalog products.

### BACKGROUND

People regularly obtain lists of item descriptors that are not matched to catalog products of an online catalog of products. These lists of item descriptors generally include generic descriptions of products. For example, a person may have a recipe for a food item that lists components of the recipe in a generic form (e.g., 1 cup milk, 2 cups of all-purpose flour, etc.). Conventionally, the customer may individually enter each component (e.g., milk) of the recipe using a search bar of, e.g., an online system, to identify and potentially purchase the corresponding product (e.g., Island Farms Organic Non-Fat Milk, 32 oz for $10.00 from Bob's Grocer). However, individually entering each item descriptor on the list to find a corresponding product to purchase can be inefficient, especially for lists with large numbers of item descriptors. Not only can it take a lot of time to identify catalog products and add them to a shopping cart in a serial manner, but it can also lead to inefficiencies in store selection. For example, as a size of a list increases, chances of all the item descriptors having corresponding catalog products available at a single store may decrease. As such, identifying catalog products in a serial fashion may result in the person not knowing how many stores are used to service an order until after each of the catalog products have been searched.

### SUMMARY

In accordance with one or more aspects of the disclosure, matching a list of item descriptors to catalog products from a database to generate personalized recommendations is described. The item descriptor to catalog item matching may be performed using one or more machine learned models. A list of item descriptors may be received at an online system, e.g., from a user client device, that includes one or more products (e.g., tomatoes, milk, juice, batteries, etc.). The online system may retrieve linking data (e.g., may describe search terms the user used and catalog products corresponding to the search terms the user added to a shopping list) for the user. The online system may determine one or more sets of ranked candidate catalog product-score pairs, where each set corresponds to a different product of the one or more item descriptors. The online system may determine the one or more sets of ranked candidate catalog product-score pairs by applying the list of one or more item descriptors and the linking data to an item association model.

The online system may build a list of recommended catalog products for the user by, for each of the at least one of the item descriptors in the list, selecting one of the set of candidate catalog products based on the generated scores. In some embodiments, the online system may build one or more lists of recommended catalog products, where each list is for a different source. In some embodiments, the online system builds the one or more lists of recommended catalog products by applying the one or more sets of ranked candidate catalog product-score pairs to a list recommendation model. In some embodiments, the online system may also apply pricing information, availability information, user source preference, or some combination thereof, to the list recommendation model in building the one or more lists of recommended catalog products. The online system may select the list of recommended catalog products from the one or more lists of recommended catalog products.

The online system may provide the list of recommended catalog products to a user client device associated with the user. The user client device is configured to present (e.g., display) the list of recommended catalog products. In some embodiments, the user client device may also offer an option to add all of the list of recommended catalog products to a shopping list. The user may add some or all of the recommended catalog products to the shopping list, and finalize the order with the online system.

In some aspects, the techniques described herein relate to a method, performed at a computer system including a processor and a non-transitory computer readable medium, including: receiving, in association with a user, a list that includes one or more item descriptors, wherein each item descriptor corresponds to one or more catalog products stored in a catalog database that includes a plurality of catalog products, each of the plurality of catalog products available from one or more sources; retrieving linking data for the user, wherein the linking data describes historical interactions by the user with one or more of the plurality of the catalog products; for at least one of the item descriptors in the list, applying an item association model to the linking data to generate a score for each of a set of candidate catalog products, wherein the item association model was trained by: accessing a set of training examples including linking data for different users, applying the item association model to the set of training examples to generate a training output corresponding to a predicted training set of catalog products and associated training scores, back-propagating one or more error terms obtained from one or more loss functions to update a set of parameters of the item association model, and one or more of the error terms are based on a difference between a label applied to a test interaction of the set of training examples and the predicted training set of catalog products and associated training scores, and stopping the back-propagation after the one or more loss functions satisfy one or more criteria; building a list of recommended catalog products for the user by, for each of the at least one of the item descriptors in the list, selecting one of the set of candidate catalog products based on the generated scores; and providing the list of recommended catalog products to a user client device associated with the user, wherein the user client device is configured to display the list of recommended catalog products.

In some aspects, the techniques described herein relate to a computer program product including a non-transitory computer readable storage medium having instructions encoded thereon that, when executed by a processor of a computer system, cause the computer system to: receive, in association with a user, a list that includes one or more item descriptors, wherein each item descriptor corresponds to one or more catalog products stored in a catalog database that includes a plurality of catalog products, each of the plurality of catalog products available from one or more sources; retrieve linking data for the user, wherein the linking data describes historical interactions by the user with one or more of the plurality of the catalog products; for at least one of the item descriptors in the list, apply an item association model to the linking data to generate a score for each of a set of candidate catalog products, wherein the item association model was trained by: accessing a set of training examples including linking data for different users, applying the item association model to the set of training examples to generate a training output corresponding to a predicted training set of catalog products and associated training scores, back-propagating one or more error terms obtained from one or more loss functions to update a set of parameters of the item association model, and one or more of the error terms are based on a difference between a label applied to a test interaction of the set of training examples and the predicted training set of catalog products and associated training scores, and stopping the back-propagation after the one or more loss functions satisfy one or more criteria; build a list of recommended catalog products for the user by, for each of the at least one of the item descriptors in the list, selecting one of the set of candidate catalog products based on the generated scores; and provide the list of recommended catalog products to a user client device associated with the user, wherein the user client device is configured to display the list of recommended catalog products.

In some aspects, the techniques described herein relate to a computer system including: a processor; and a non-transitory computer readable storage medium having instructions encoded thereon that, when executed by the processor, cause the computer system to: receive, in association with a user, a list that includes one or more item descriptors, wherein each item descriptor corresponds to one or more catalog products stored in a catalog database that includes a plurality of catalog products, each of the plurality of catalog products available from one or more sources, retrieve linking data for the user, wherein the linking data describes historical interactions by the user with one or more of the plurality of the catalog products, for at least one of the item descriptors in the list, apply an item association model to the linking data to generate a score for each of a set of candidate catalog products, wherein the item association model was trained by: accessing a set of training examples including linking data for different users, applying the item association model to the set of training examples to generate a training output corresponding to a predicted training set of catalog products and associated training scores, back-propagating one or more error terms obtained from one or more loss functions to update a set of parameters of the item association model, and one or more of the error terms are based on a difference between a label applied to a test interaction of the set of training examples and the predicted training set of catalog products and associated training scores, and stopping the back-propagation after the one or more loss functions satisfy one or more criteria, build a list of recommended catalog products for the user by, for each of the at least one of the item descriptors in the list, selecting one of the set of candidate catalog products based on the generated scores, and provide the list of recommended catalog products to a user client device associated with the user, wherein the user client device is configured to display the list of recommended catalog products.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIG. 3 is an example sequence diagram describing matching a list of item descriptors to catalog products from a database to generate personalized recommendations, in accordance with some embodiments.

FIG. 4 illustrates an example ordering interface that is presenting a list of recommended catalog products, in accordance with some embodiments.

FIG. 5 is a flowchart for a method of matching a list of item descriptors to catalog products from a database to generate personalized recommendations, in accordance with some embodiments.

### DETAILED DESCRIPTION

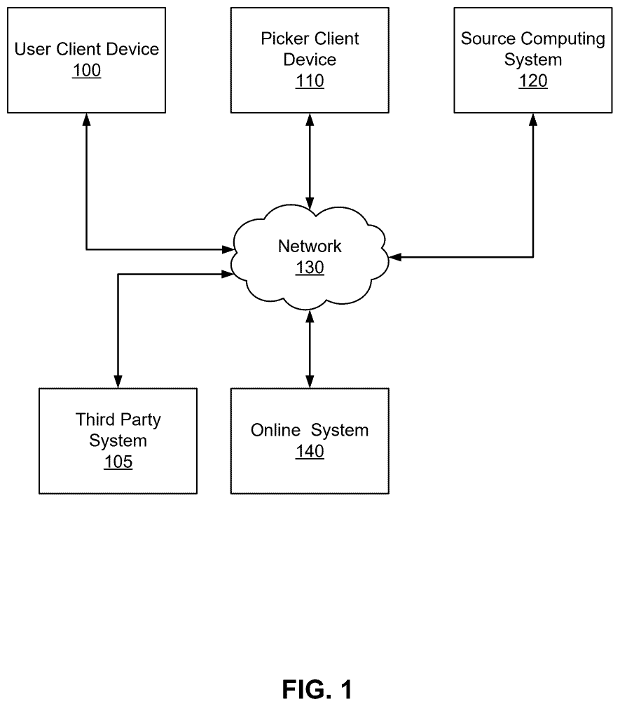

FIG. 1 illustrates an example system environment for an online system 140, in accordance with one or more embodiments. The system environment illustrated in FIG. 1 includes a user client device 100, a third party system 105, a picker client device 110, a source computing system 120, a network 130, and an online system 140. In some embodiments, the online system 140 may be an online concierge system. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and sources may be generically referred to as “users” of the online system 140. Additionally, while one user client device 100, third party system 105, picker client device 110, and source computing system 120 are illustrated in FIG. 1, any number of customers, pickers, and sources may interact with the online system 140. As such, there may be more than one user client device 100, third party system 105, picker client device 110, or source computing system 120.

The user client device 100 is a client device through which a user may interact with the third party system 105, the picker client device 110, the source computing system 120, or the online system 140. The user client device 100 can be a personal or mobile computing device, such as a smartphone, a tablet, a laptop computer, or desktop computer. In some embodiments, the user client device 100 includes a camera. In some embodiments, the user client device 100 executes a client application that uses an application programming interface (API) to communicate with the online system 140. In some embodiments, the user client device 100 may include an application that communicates with the third party system 105.

A user uses the user client device 100 to place an order with the online system 140. An order specifies a set of products to be delivered to the user. A product that is part of an online catalog (may also referred to as a catalog database) is referred to as a catalog product. A “product,” as used herein, means a good or service that can be provided to the user through the online system 140. The order may include product identifiers (e.g., a stock keeping unit or a price look-up code) for catalog products to be delivered to the user and may include quantities of the catalog products to be delivered. Additionally, an order may further include a delivery location to which the ordered catalog products are to be delivered and a timeframe during which the catalog products should be delivered. In some embodiments, the order also specifies one or more sources (e.g., retailers) from which the ordered catalog products should be collected.

The user client device 100 presents an ordering interface to the user (e.g., customer). The ordering interface is a user interface that the user can use to place an order with the online system 140. The ordering interface may be part of a client application operating on the user client device 100. The ordering interface allows the user to search for catalog products that are available through the online system 140 and the user can select which catalog products to add to a “shopping list.” A “shopping list,” as used herein, is a tentative set of catalog products that the user has selected for an order but that has not yet been finalized for an order. The ordering interface allows a user to update the shopping list, e.g., by changing the quantity of catalog products, adding or removing catalog products, or adding instructions for catalog products that specify how the catalog product should be collected.

The user client device 100 may receive a list of item descriptors. An item descriptor is a generic description of an item (e.g., a good and/or service). For example, an item descriptor may be, e.g., milk, ketchup, mustard, yoga lesson, etc. An item descriptor is not linked or indexed to an individual catalog product in the online catalog of the online system 140, whereas catalog items that are for sale are in the online catalog. A list of one or more item descriptors may be, e.g., an image of a list (e.g., hand written and/or typed) of one or more item descriptors, text strings corresponding to some or all of the one or more item descriptors, or some combination thereof. In some embodiments, the user client device 100 may process the list of item descriptors prior to providing it to the online system 140. For example, the user client device may process an image of the list to determine text strings corresponding to some or all of the one or more item descriptors.

The user client device 100 may receive a list of one or more item descriptors in different ways. For example, the user client device 100 may receive a list of one or more item descriptors by taking a photo of the list of item descriptors using a camera of the user client device 100. In another example, the user client device 100 can receive the list from an app running on the user client device 100. In some embodiments, the app is associated with the third party system 105. In some embodiments, the user client device 100 may receive the list from the third party system 105.

The user client device 100 may receive a matching request. Responsive to receiving a matching request, the user client device 100 may provide the list of one or more item descriptors to the online system 140. For example, the user client device 100 may present an option for product matching, where if selected, the user client device 100 sends the list to the online system 140. In other embodiments, the user may use the third party system 105 and/or app to generate a list of item descriptors. The third party system 105 and/or app may present a prompt on the user client device 100 to shop for the products described by the item descriptors using the online system 140. Responsive to a selection of the prompt (i.e., receiving a product matching request), the user client device 100 may provide the list to the online system 140.

The user client device 100 receives a list of recommended catalog products from the online system 140. The list includes catalog product recommendations, where the catalog product recommendations correspond to some or all of the item descriptors that make up the list. In some embodiments, there is a catalog product recommendation for each item descriptor of the list of one or more item descriptors. The user client device 100 presents, e.g., via an ordering interface, the catalog product recommendations for potential selection and purchase.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The third party system 105 is a computing system operated by a third party company that interacts with the online system 140 and/or the user client device 100. The third party system 105 may be used to, e.g., develop a list of item descriptors. For example, the third party system 105 may be a website that allows a user to search for different recipes using a browser on the user client device 100, and see what lists of item descriptors (e.g., milk, flour, eggs) are used to make those recipes. In some embodiments, the third party system 105 may receive from the user client device 100 instructions to add one or more item descriptors to a list of item descriptors. The third party system 105 may provide the list of item descriptors to the user client device 100 and/or the online system 140.

The picker client device 110 is a client device through which a picker may interact with the user client device 100, the source computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the products listed in the order from a source (e.g., retailer). The picker client device 110 presents the products that are included in the order to the picker in a collection interface. The collection interface is a user interface that provides information to the picker on which products to collect for a user's order and the quantities of the products. In some embodiments, the collection interface provides multiple orders from multiple users for the picker to service at the same time from a same source location. The collection interface further presents instructions that the user may have included related to the collection of products in the order. Additionally, the collection interface may present a location of each product in the source location, and may even specify a sequence in which the picker should collect the products for improved efficiency in collecting products. In some embodiments, the picker client device 110 transmits to the online system 140 or the user client device 100 which products the picker has collected in real time as the picker collects the products.

The picker can use the picker client device 110 to keep track of the products that the picker has collected to ensure that the picker collects all of the products for an order. The picker client device 110 may include a barcode scanner that can determine a product identifier encoded in a barcode coupled to a product. The picker client device 110 compares this product identifier to products in the order that the picker is servicing, and if the product identifier corresponds to a product in the order, the picker client device 110 identifies the product as collected. In some embodiments, rather than or in addition to using a barcode scanner, the picker client device 110 captures one or more images of the product and determines the product identifier for the product based on the images. The picker client device 110 may determine the product identifier directly or by transmitting the images to the online system 140. Furthermore, the picker client device 110 determines a weight for products that are priced by weight. The picker client device 110 may prompt the picker to manually input the weight of a product or may communicate with a weighing system in the source location to receive the weight of a product.

When the picker has collected all of the products for an order, the picker client device 110 instructs a picker on where to deliver the products for the order. For example, the picker client device 110 displays a delivery location from the order to the picker. The picker client device 110 also provides navigation instructions for the picker to travel from the source location to the delivery location. Where a picker is servicing more than one order, the picker client device 110 identifies which products should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the products to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user such that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects products for an order from a source location and delivers the order to the delivery location for the order. Alternatively, more than one person may serve the role as a picker for an order. For example, multiple people may collect the products at the source location for a single order. Similarly, the person who delivers an order to its delivery location may be different from the person or people who collected the products from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

The source computing system 120 is a computing system operated by a source (e.g., retailer) that interacts with the online system 140. As used herein, a “source” is an entity that operates a “source location,” which is a store, warehouse, or other building from which a picker can collect items. The source computing system 120 stores and provides product data to the online system 140 and may regularly update the online system 140 with updated product data. For example, the source computing system 120 provides product data indicating which products are available at a source location and the quantities of those products. Additionally, the source computing system 120 may transmit updated product data to the online system 140 when a product is no longer available at the source location. Additionally, the source computing system 120 may provide the online system 140 with updated product prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the third party system 105, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 matches a list of one or more item descriptors to catalog products from a database to generate personalized recommendations for catalog products. The online system 140 may receive from the user client device 100 a list of one or more item descriptors (e.g., an image of the list, text strings corresponding to some or all of the one or more item descriptors, or some combination thereof). In some embodiments, the online system 140 may process the list to extract information (e.g., text strings corresponding to the one or more item descriptors) about the one or more item descriptors. The online system 140 may retrieve linking data for a user associated with the user client device 100. Linking data for a user describes item descriptors and/or search terms for those item descriptors and catalog products corresponding to the item descriptors and/or search terms that the user added to their shopping list.

The online system 140, for the one or more item descriptors in the list, may apply an item association (IA) model to the linking data to generate a score for each of a set of candidate catalog products. Each set of candidate catalog products corresponds to an item descriptor of the one or more item descriptors. For example, the online system 140 may determine one or more sets of ranked candidate catalog product-score pairs using the IA model. Each set of candidate catalog product-score pairs corresponds to a different item descriptor of the one or more item descriptors. The online system 140 may determine the one or more sets of ranked candidate catalog product-score pairs by applying information (e.g., text strings) describing the one or more item descriptors and the linking data to the IA model.

The online system 140 may build a list of recommended catalog products for the user by, for each of the one or more item descriptors, selecting one of the set of candidate catalog products based on the generated scores. In some embodiments, the online system 140 may build one or more lists of recommended catalog products that are matched to some or all of the one or more item descriptors by applying the one or more sets of ranked candidate catalog product-score pairs to a List Recommendation (LR) model. Each catalog product recommendation is for a catalog product that is selected from the set of the one or more sets of ranked candidate catalog product-score pairs. In some embodiments, the LR model may use pricing information for the ranked candidate catalog product-score pairs, availability information for the ranked candidate catalog product-score pairs, user data (e.g., favorite retailers of the user), or some combination thereof to adjust scores and re-rank the candidate catalog product-score pairs in some or all of the one or more sets. The online system 140 may then form one or more lists of recommended catalog products (e.g., a list for each potential source) using the one or more sets of re-ranked candidate catalog product-score pairs. The online system 140 may provide the one or more lists to the user client device 100. Note in some embodiments, the online system 140 may generate a single list of recommended catalog product(s) and provide that to the user client device 100 for presentation (e.g., via the ordering interface). In other embodiments, where there are multiple lists of recommended catalog product(s), a user may select which source they want to shop at, and the user client device 100 presents catalog product recommendations for the list associated with the selected source. The online system 140 may receive an order for some or all of the catalog products associated with the list provided to the user client device 100.

In the above manner, the online system 140 is able to provide catalog product recommendations that correspond to the one or more catalog products, where the catalog products are actually personalized to the user (e.g., the online system 140 associates “milk” from a list of a user to correspond to “a half gallon of Island Dairy non-fat Organic Milk”). In some embodiments, the online system 140 may also instruct the client user device 100 to present a select all option, that if selected, adds all the items associated with the list of recommended catalog products to a shopping list for the order. Accordingly, the online system 140 can greatly simplify both identifying a specific catalog product for each item descriptor of a list as well as the purchase of the specific catalog products.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. The picker collects the ordered catalog products from a source location and delivers the ordered catalog products to the user. The online system 140 may charge a user for the order and provide portions of the payment from the user to the picker and the source.

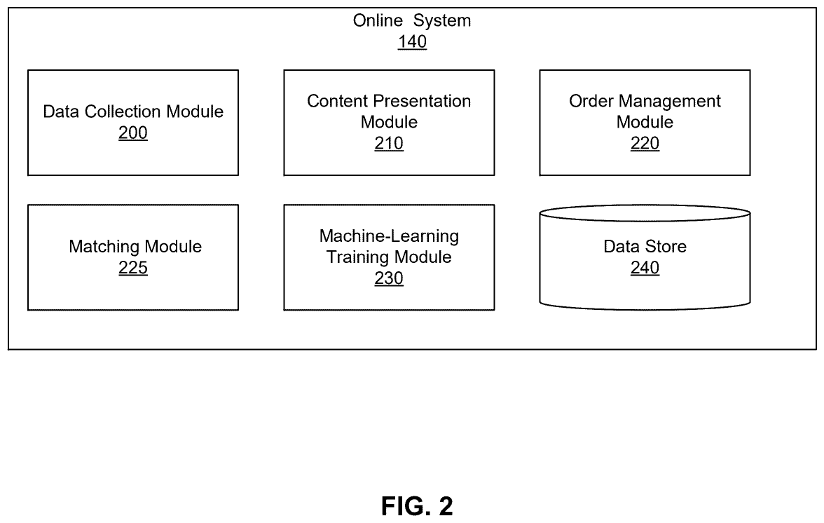

As an example, the online system 140 may allow a user to order groceries from a grocery store retailer. The user's order may specify which groceries they want delivered from the grocery store and the quantities of each of the groceries. The user client device 100 transmits the user's order to the online system 140 and the online system 140 selects a picker to travel to the grocery store source location to collect the groceries ordered by the user. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a matching module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite sources, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects product data, which is information or data that identifies and describes catalog products that are available at a source location. The product data may include product identifiers for products that are available and may include quantities of products associated with each product identifier, and prices for the products. Additionally, product data may also include attributes of products such as the size, color, weight, stock keeping unit (SKU), price look up code, or serial number for the product. The product data may further include purchasing rules associated with each product, if they exist. For example, age-restricted products such as alcohol and tobacco are flagged accordingly in the product data. Product data may also include information that is useful for predicting the availability of products in source locations. For example, for each product-source combination (a particular product at a particular warehouse), the product data may include a time that the product was last found, a time that the product was last not found (a picker looked for the product but could not find it), the rate at which the product is found, or the popularity of the product. The data collection module 200 may collect product data from a source computing system 120, a picker client device 110, or the user client device 100.

A product category is a set of products that are a similar type of product. Products in a product category may be considered to be equivalent to each other or that may be replacements for each other in an order. For example, different brands of sourdough bread may be different products, but these products may be in a “sourdough bread” product category. The product categories may be human-generated and human-populated with items. The product categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include product data for products that are included in the order, a delivery location for the order, a user associated with the order, a source location from which the user wants the ordered products collected, or a timeframe within which the user wants the order delivered. Order data may further include information describing how the order was serviced, such as which picker serviced the order, when the order was delivered, or a rating that the user gave the delivery of the order.

The data collection module 200 also collects linking data. Linking data for a user describes item descriptors and/or search terms for those item descriptors, and catalog products corresponding to the item descriptors and/or search terms that the user added to their shopping list. The data collection module 200 may track item descriptors and/or search terms associated with a user, and also track what corresponding catalog products the user added to the shopping list. The data collection module 200 may store linking data for users in the data store 240.

For example, a user may have searched for “milk” using an ordering interface of their user client device 100, and responsive to being presented (e.g., via the ordering interface) with various catalog product recommendations for milk, added “a half gallon of Island Dairy non-fat Organic Milk.” Similarly, the online system 140 may have received a list of item descriptors that included “milk” from the user client device 100, and responsive to being presented (e.g., via the ordering interface) with various catalog product recommendations for different catalog products corresponding to milk, the user may have added “a half gallon of Island Dairy non-fat Organic Milk.” Accordingly, in this example, the linking information may map an item descriptor (i.e., “milk”) to a catalog product (i.e., “a half gallon of Island Dairy non-fat Organic Milk”).

The data collection module 200 may weight an association between an item descriptor and/or search term with one or more corresponding catalog products. And, over time, as more search terms and/or item descriptors are used and corresponding catalog products are added to the shopping list, the data collection module 200 can refine the weightings to reflect a probability of the user to associate an item descriptor and/or search term with a specific catalo product. Continuing with the example above, the weightings may be such that the user 70% of the time chooses “a half gallon of Island Dairy non-fat Organic Milk,” but 30% of the time choses “a half gallon of Happy Cows non-fat Organic Milk.”

The content presentation module 210 selects content for presentation to a user. For example, the content presentation module 210 selects which catalog products to present to a user while the user is placing an order. The content presentation module 210 generates and transmits the ordering interface for the user to order catalog products. The content presentation module 210 populates the ordering interface with catalog products that the user may select for adding to their order. In some embodiments, the content presentation module 210 presents a catalog of all catalog products that are available to the user, which the user can browse to select catalog products to order. The content presentation module 210 also may identify catalog products that the user is most likely to order and present those catalog products to the user. For example, the content presentation module 210 may score catalog products and rank the catalog products based on their scores. The content presentation module 210 displays the catalog products with scores that exceed some threshold (e.g., the top n items or the p percentile of items).

The content presentation module 210 may use a product selection model to score catalog products for presentation to a user. A product selection model is a machine learning model that is trained to score items for a user based on product data for the catalog products and user data for the user. For example, the product selection model may be trained to determine a likelihood that the user will order the catalog product. In some embodiments, the product selection model uses product embeddings describing catalog products and user embeddings describing users to score catalog products. These catalog product embeddings and user embeddings may be generated by separate machine learning models and may be stored in the data store 240.

In some embodiments, the content presentation module 210 scores catalog products based on a search query received from the user client device 100. A search query is text for a word or set of words that indicate products of interest to the user. The content presentation module 210 scores catalog products based on a relatedness of the catalog products to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate catalog products for presentation to a user (e.g., by comparing a search query embedding to a catalog product embedding).

In some embodiments, the content presentation module 210 scores catalog products based on a predicted availability of a catalog product. The content presentation module 210 may use an availability model to predict the availability of a catalog product. An availability model is a machine learning model that is trained to predict the availability of a catalog product at a source location. For example, the availability model may be trained to predict a likelihood that a catalog product is available at a source location or may predict an estimated number of catalog products that are available at a source location. The content presentation module 210 may weight the score for a catalog product based on the predicted availability of the catalog product. Alternatively, the content presentation module 210 may filter out catalog products from presentation to a user based on whether the predicted availability of the catalog product exceeds a threshold.

The order management module 220 manages orders for catalog products from users. The order management module 220 receives orders from a user client device 100 and assigns the orders to pickers for service based on picker data. For example, the order management module 220 assigns an order to a picker based on the picker's location and the location of the source location from which the ordered items are to be collected. The order management module 220 may also assign an order to a picker based on how many products are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the products for an order and deliver the ordered products to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect catalog products at the source location, the order management module 220 receives product identifiers for items that the picker has collected for the order. In some embodiments, the order management module 220 receives images of products from the picker client device 110 and applies computer-vision techniques to the images to identify the products depicted by the images. The order management module 220 may track the progress of the picker as the picker collects products for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit to the picker client device 110 instructions to display a map of the source location indicating where in the source location the picker is located. Additionally, the order management module 220 may instruct the picker client device 110 to display the locations of products for the picker to collect, and may further display navigation instructions for how the picker can travel from their current location to the location of a next product to collect for an order.

The order management module 220 determines when the picker has collected all of the products for an order. For example, the order management module 220 may receive a message from the picker client device 110 indicating that all of the products for an order have been collected. Alternatively, the order management module 220 may receive product identifiers for products collected by the picker and determine when all of the products in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of their order. In some embodiments, the order management module 220 computes an estimated time of arrival for the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the source.

The matching module 225 may receive from the user client device 100 a list that includes one or more item descriptors for one or more items. The matching module 225 may determine a text representation of each of the one or more item descriptors. In some embodiments, the list may be a list of text strings associated with different item descriptors, and the matching module 225 extracts the text strings from the list. In some embodiments, the list may be a photo of a list of item descriptors (e.g., milk, sugar, etc.). The matching module 225 may use, e.g., object recognition techniques and/or optical character recognition techniques on the photo to determine text strings associated with some or all of the item descriptors on the list.

The matching module 225 may retrieve linking data for a user associated with the user client device 100. The matching module 225 may retrieve the linking data from the data store 240.

The matching module 225 may perform item descriptor-to-catalog product matching using one or more machine learned models. For example, the matching module 225 may, for some or all of the item descriptors in the list, apply the IA model to the linking data to generate a score for each of a set of candidate catalog products. In some embodiments, the matching module 225 can apply the list of one or more item descriptors (e.g., text strings corresponding to the one or more products) and the linking data for the user to the IA model to determine one or more sets of ranked candidate catalog product-score pairs. The IA model is a machine learned model that is configured to use the linking data for the user to match item descriptors on the list to corresponding sets of ranked candidate catalog product-score pairs. Each set corresponds to a different item descriptor of the one or more item descriptors on the list. A candidate catalog product-score pair includes a catalog product that is part of the online catalog, and a score for that catalog product. Each of the candidate catalog product-score pairs in a set are ranked according to their score. For example, a set of ranked candidate catalog product-score pairs for an item descriptor (“milk”) for an example user is shown below with regard to Table 1.

TABLE 1
Example set of candidate catalog products corresponding to “milk”

| Rank | Candidate Catalog Product | Score |
|---|---|---|
| 1 | Island Farm's Organic Non-Fat milk, 0.5 gallon | 0.5 |
| 2 | Island Farm's Non-Fat milk, 0.5 gallon | 0.3 |
| 3 | Happy Cow Whole milk, 0.5 gallon | 0.1 |

The matching module 225 may build a list of recommended catalog products for the user by, for each of the at least one of the item descriptors in the list, selecting one of the set of candidate catalog products based on the generated scores. Note that the IA model matches descriptors to catalog products in the online catalog based on the linking data, but the matching may be irrespective of pricing, availability, and source preference. The matching module 225 may take into account these other factors using the LR model to build the list of recommended catalog products. The LR model is a machine learned model that may be used to build one or more lists of recommended catalog products. A list of recommended catalog products is for a specific source, and includes a recommended catalog product from some or all of the one or more sets.

The matching module 225 may retrieve one or more model inputs to be applied to the LR model. The model inputs include the one or more sets, and may also include, e.g., pricing information for each of the candidate catalog products in each of the one or more sets, availability information for each of the candidate catalog products in each of the one or more sets, source preferences for the user, or some combination thereof. The matching module 225 may determine the pricing information and availability information using product data for the candidate catalog products in each of the one or more sets. In some embodiments, the matching module 225 may coordinate with one or more source computing systems (e.g., the source computing system 120) to receive updated product data that includes the availability information and the pricing information.

The matching module 225 may build one or more lists of recommended catalog products using the one or more sets of ranked candidate catalog product-score pairs output from the IA model. The matching module 225 may apply the one or more sets of ranked candidate catalog product-score pairs, and in some case one or more of the model inputs, to the LR model to obtain the one or more lists of recommended catalog products. For each of the one or more sets, the LR model may adjust scores of the candidate catalog product-score pairs based on an optimization of one or more of: pricing, availability, and source preference of the user. The LR model may re-rank the candidate catalog product-score pairs using the adjusted scores, and select a highest ranking candidate catalog product for inclusion into a list of recommended catalog products for a source. The LR model may repeat this process for each set, to build out the list of recommended catalog products for the source.

In some embodiments, the LR model may generate a plurality of lists of recommended catalog products, where each list is for a different source. In some embodiments where there are a plurality of lists of recommended catalog products, the LR model may score and rank each of the plurality of lists, and select the list with the highest rank to be provided to the user client device 100.

The matching module 225 provides the one or more lists of recommended catalog products to the user client device 100. In some embodiments, the matching module 225 may provide a single list (e.g., a single source case or a list having a highest score). In other embodiments, the matching module 225 may provide multiple lists to the user client device 100. The user may select which source they want to shop at, and the user client device 100 presents the recommended catalog products for the list associated with the selected source. In some embodiments, the matching module 225 may also instruct the client user device 100 to present a select all option, that if selected by the user, adds all the recommended catalog products associated with the list to a shopping list. The online system 140 may receive an order for some or all of the catalog products associated with the list of recommended catalog products.

The machine learning training module 230 trains machine learning models (e.g., IA model, the LR model) used by the online system 140. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. Each training example may include linking data, user data, picker data, product data, order data, or some combination thereof. For example, training the IA model may use training examples that include linking data for different users. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

For example, the machine learning training module 230 may train the AI model. The machine learning training module 230 may access (e.g., from the data store 240) a set of training examples including linking data for different users. The machine learning training module 230 may apply the IA model to the set of training examples to generate a training output corresponding to a predicted training set of items and associated training scores. The machine learning training module 230 may back-propagate one or more error terms obtained from one or more loss functions to update a set of parameters of the IA model, and one or more of the error terms are based on a difference between a label applied to a test interaction of the set of training examples and the predicted training set of catalog products and associated training scores. The machine learning training module 230 may stop the back-propagation after the one or more loss functions satisfy one or more criteria.

In some embodiments, the machine learning training module 230 may update the IA model and/or the LR model. For example, over time, the linking data for a user may evolve as more data is gathered. The machine learning training module 230 may retrain the IA model using the evolved set of linking data. In some embodiments, the machine learning training module 230 may determine additional training examples using list(s) of recommended catalog products provided to the user client device 100, addition of items to a shopping list of the user and/or purchase by the user of the recommended catalog product(s) responsive to the list(s) being displayed on the user client device. The machine learning training module 230 may retrain the item association model based in part on the additional training examples.

The data store 240 stores data used by the online system 140. For example, the data store 240 stores user data, product data, order data, linking data, lists of recommended catalog products, and picker data for use by the online system 140. The data store 240 also stores trained machine learning models (e.g., IA model and/or LR model) trained by the machine learning training module 230. For example, the data store 240 may store the set of parameters for a trained machine learning model on one or more non-transitory, computer-readable media. The data store 240 uses computer-readable media to store data, and may use databases to organize the stored data.

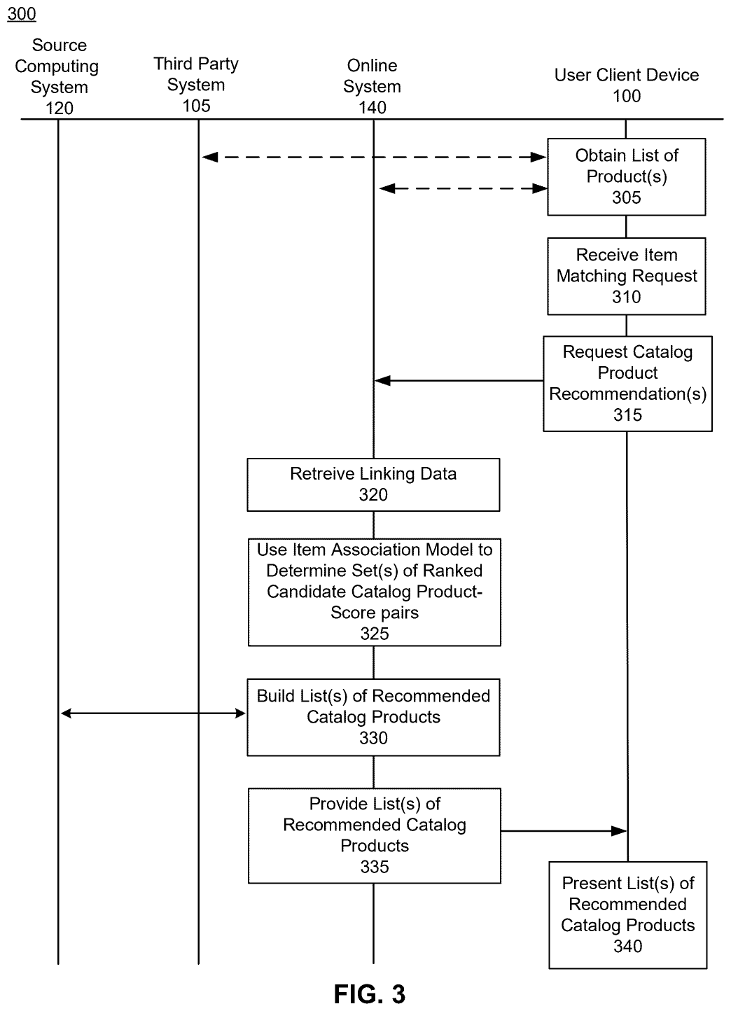

FIG. 3 is an example sequence diagram 300 describing matching a list of item descriptors to catalog products from a database to generate personalized recommendations, in accordance with some embodiments. Alternative embodiments may include more, fewer, or different interactions from those illustrated in FIG. 3, and the steps may be performed in a different order from that illustrated in FIG. 3.

The user client device 100 obtains 305 a list of one or more item descriptors for one or more items. For example, a user may use the user client device 100 to capture a photo of the list. In another example, the user client device 100 may receive the list from a third party system 105 and/or an app on the user client device 100 that is associated with the third party system 105. For example, the user may coordinate via the user client device 100 with the third party system 105 to assemble the list, and receive the assembled list from the third party system 105.

Note that in some embodiments, the list of products may come from the online system 140. For example, the online system 140 may provide one or more recipes to the user client device 100, wherein each recipe is associated with a different list of products. The user client device 100 may receive a selection of a recipe, of the one or more recipes, and the user client device 100 and/or the online system may extract the list of products (in this case recipe ingredients) from the selected recipe.

The user client device 100 may receive 310 an item matching request. Responsive to receiving an item matching request, the user client device 100 requests 315 from the online system 140 catalog product recommendations for some or all of the item descriptors on the list. For example, the user client device 100 may present an option for item matching to the user. In some embodiments, after the option is selected (i.e., receiving an item matching request), the user client device 100 requests catalog product recommendations for some or all of the item descriptors on the list from the online system 140. In some embodiments, the user is able to choose which item descriptors to match to catalog products. In other embodiments, the user client device 100 automatically selects all item descriptors for matching to catalog products. In some embodiments, after the option is selected (i.e., receiving an item matching request), the user client device processes the list of item descriptors to determine information about the item descriptors (e.g., text strings), and then provides 325 the list (image of the list, text strings corresponding to some or all of the item descriptors, or some combination thereof) of one or more item descriptors to the online system 140. In some embodiments, the online system 140 may process the list of item descriptors to determine the information about the item descriptors.

The online system 140 may retrieve 320 linking data for the user associated with the user client device 100. The online system 140 may retrieve the linking data from the data store 240.

The online system 140 may use 325 the IA model to determine one or more sets of ranked candidate catalog product-score pairs. Each set of ranked candidate catalog product-score pairs is associated with a different item descriptors on the list of products. For example, the online system 140 may determine the sets of ranked candidate catalog product-score pairs by applying information (e.g., text strings) describing the item descriptors and the linking data to the IA model.

The online system 140 may build 330 one or more lists of recommended catalog products. The online system 140 may retrieve one or more model inputs to be applied to the LR model. The model inputs include the sets of ranked candidate catalog product-score pairs, and may also include, e.g., pricing information for each of the candidate catalog products in each of the sets, availability information for each of the candidate catalog products in each of the one or more sets, source preferences for the user, or some combination thereof. In some embodiments, the online system 140 requests pricing information and availability information from one or more source computing systems (e.g., the source computing system 120). The online system 140 receives the requested pricing information and availability information and updates the model inputs with them. The online system 140 builds the one or more lists of recommended catalog products by applying one or more of the model inputs to the LR model. Each list may be specific to a source and includes recommendations for catalog products. Each recommendation is for a catalog product from one of the sets. In some embodiments, a list may include a recommended catalog product for every item descriptor on the list received from the user client device 100.

The online system 140 provides 335 some or all of the one or more lists of recommended catalog products to the user client device 100. In some embodiments, the online system 140 may instruct the client user device 100 to present a select all option, that if selected by the user, adds all the recommended catalog products of a list to a shopping list.

The user client device 100 presents 340 the list(s) of recommended catalog products. The user client device 100 may present the list of recommended catalog products in accordance with instructions from the online system 140. The user client device 100 may present the recommended catalog products via a user interface (e.g., the ordering interface). In some embodiments, the item descriptor may be presented with its corresponding catalog product recommendation. For example, “milk” may be presented adjacent to a catalog product recommendation for “Island Farms Organic Non-Fat Milk.” In some embodiments, the ordering interface may also present a select all option, to allow the user to easily add all the recommended catalog products to a shopping list. In some embodiments, the user may add some or all of the recommended catalog products associated with the item descriptors to a shopping list, and finalize the order with the online system 140.

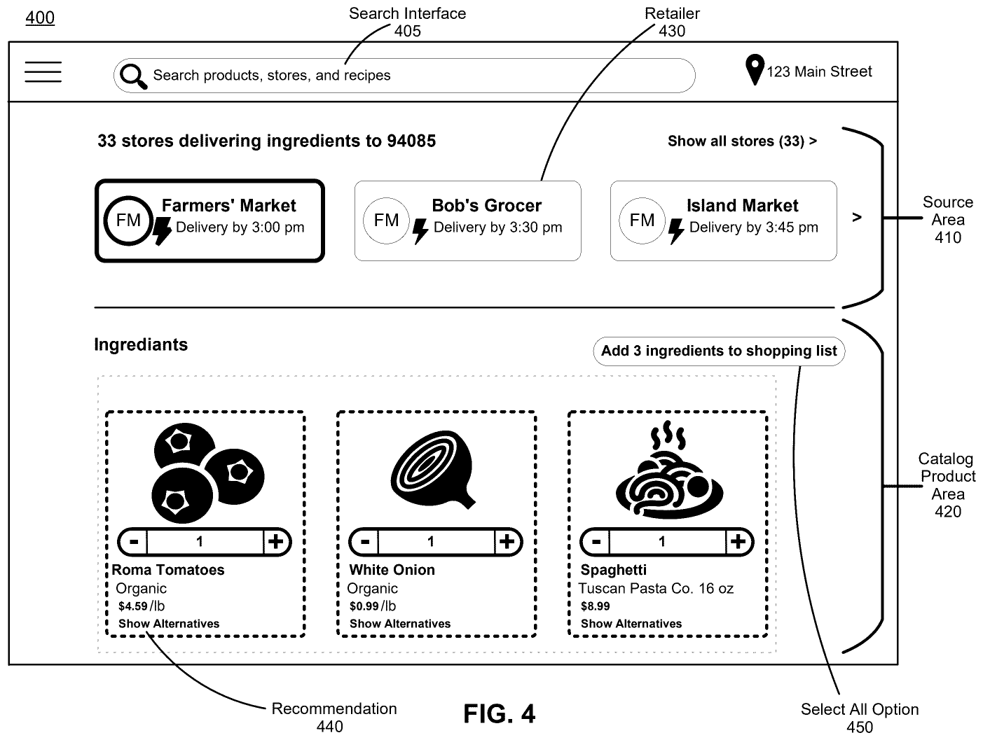

FIG. 4 illustrates an example ordering interface 400 that is presenting a list of recommended catalog products, in accordance with some embodiments. The ordering interface 400 is an embodiment of the ordering interface described above with regard to FIGS. 1-3. The ordering interface 400 may be presented on the user client device 100. The ordering interface 400 is a user interface that presents recommendations for catalog products that correspond to item descriptors on a list provided by the user client device 100. The item descriptors have generic names. For example, the list provided by the user client device 100 may be for onions, tomatoes, and spaghetti. In the illustrated embodiment, the ordering interface 400 includes at least a search interface 405 (e.g., used to search the online catalog), a source area 410, and a catalog product area 420. In other embodiments, the ordering interface 400 includes different or additional elements. In addition, the functions may be distributed among the elements in a different manner than described.

Note that a list of recommended catalog products may be for a specific source. Accordingly, in the illustrated embodiment, there are potentially 33 different lists of recommended catalog products, one for each source. In some embodiments different lists may include recommendations for the same catalog products-but potentially differ in price. However, in some embodiments, different lists may include recommendations for different catalog products. For example, a list for a first source may have a recommended catalog product for every item descriptor, while a list for a second source may be similar except that it does not stock a catalog product that corresponds to an item descriptor on the list from the user client device 100. In other embodiments, the list of recommended catalog products for a first source may include recommendation for a first catalog product that corresponds to a first item descriptor on the list of item descriptors. And the second source may have a recommendation for a second catalog product that is different from the first catalog product (e.g., may substitute the first catalog product with the second catalog product if the first catalog product is unavailable), but still corresponds to the first catalog product.

The source area 410 presents one or more sources (e.g., retailer 430) that are associated with corresponding lists of recommended catalog products. In the source area 410 a user may select a source to see recommendations for catalog products corresponding to item descriptors on the list of item descriptors that are available to purchase. In the illustrated embodiment, the selected source is the Farmers' Market, and the catalog product area 420 includes recommendations for catalog products specific to the list of recommended catalog products for Farmers' Market. If some other source is selected, e.g., Bob's Grocer, the catalog product area 420 would present recommendations of catalog products specific to the list for Bob's Grocer. In some embodiments, the ordering interface 400 may emphasize the source that is the selected source.

The catalog product area 420 presents information describing various catalog products that are for sale from the selected source (e.g., Farmers' Market) that are on a list of recommended catalog sources for that source. In the illustrated example, the catalog product area 420 presents recommendations (e.g., recommendation 440) for catalog products that correspond to a list of recommended catalog products associated with Farmers' Market. Each of the recommendations are for catalog products that correspond to item descriptors on the list. For example, as shown the catalog product area 420 presents a recommendation 440 for organic Roma Tomatoes which correspond to “tomatoes,” a recommendation for organic white onions that correspond to “onions,” and a recommendation for spaghetti from the Tuscan Pasta Co. that corresponds to “spaghetti.” In the illustrated embodiment, the catalog product area 420 also includes a select all option 450, that once selected adds all of the recommended catalog products associated with the list of the selected source to a shopping list. For example, in the illustrated embodiment, selection of the select all option 450 would add the three recommended catalog products to the shopping list.

Note that the item descriptors on the list of item descriptors are not part of the online catalog and are just general descriptions. In the illustrated embodiment, the online system 140 used the item descriptors of items to generate list(s) of recommended catalog products that correspond to some or all of those items at different sources. Moreover, the recommendations of catalog products that are presented, not only correspond to item descriptors used by the user, but are tailored to the user (e.g., using linking data and an IA model).

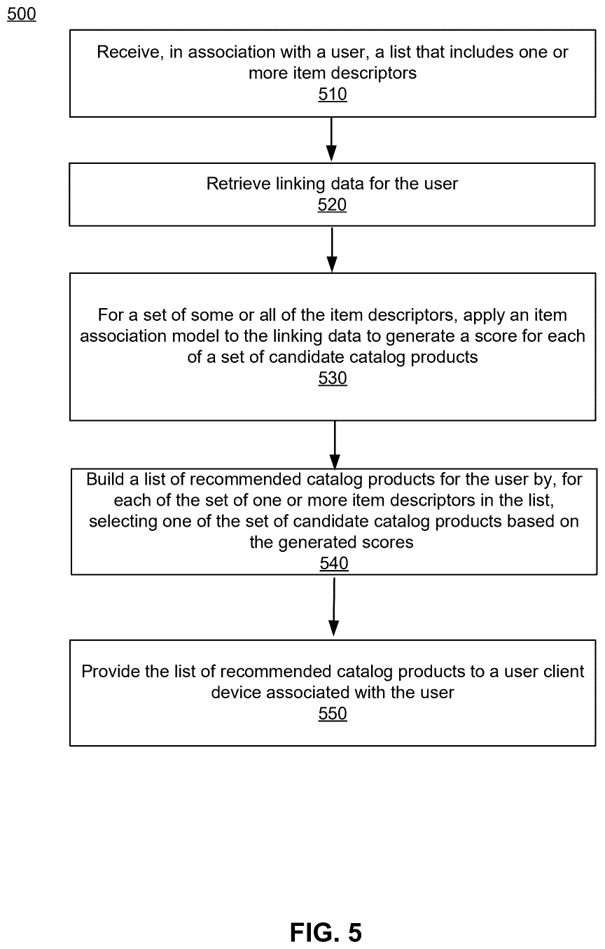

FIG. 5 is a flowchart for a method of matching a list of item descriptors to catalog products from a database to generate personalized recommendations, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system receives 510 receives a list that includes one or more item descriptors. The list is associated with a user, and each item descriptor corresponds to one or more catalog products stored in an online catalog (e.g., a catalog database) that includes a plurality of catalog products. For example, the list may be for “soap” and “shampoo.” The list and/or information describing the list is received from a user client device (e.g., the user client device 100) that is associated with a user. For example, the list may be text strings describing the one or more item descriptors, an image of the list, or some combination thereof.

The online system retrieves 520 linking data for the user. The linking data describes historical interactions by the user with one or more of the plurality of the catalog products. For example, the linking data may describe item descriptors and/or search terms, and catalog products corresponding to the item descriptors and/or search terms that the user added to their shopping list. In some embodiments, the linking data describes what search terms the user used and what catalog products corresponding to the search terms the user added to the shopping list. The online system may retrieve the linking data for the user from a data store (e.g., the data store 240).

The online system builds 530 a list of recommended catalog products for the user by, for each of a set of one or more of the item descriptors in the list, selecting one of the set of candidate catalog products based on the generated scores. For example, the online system may determine one or more sets of ranked candidate catalog product-score pairs, by applying the list of the one or more item descriptors and the linking data to an IA model. Each set of the one or more sets of ranked candidate catalog product-score pairs corresponds to a different item descriptor. Continuing with the example above, a set corresponding to “soap” may include multiple catalog products that each have a score (e.g., “Irish Spring Men's Bar Soap, Original Clean,” 3×3.7 oz, score of 0.5; “Dove Beauty Bar More Moisturizing Than Bar Soap Sensitive Skin,” 2×4 oz, etc., score of 0.2; etc.).

The online system builds 540 a list of recommended catalog products for the user by, for each of the set of one or more of the item descriptors in the list, selecting one of the set of candidate catalog products based on the generated scores. For example, the online system may build the one or more lists of recommended catalog products, by applying the one or more sets of ranked candidate catalog product-score pairs to a LR model. Each list of recommended catalog products may be specific to a source, and include for one or more item descriptors corresponding catalog product recommendations.

The online system provides 550 the list of recommended catalog products to a user client device associated with the user. The user client device is configured to present (e.g., display) the list of recommended catalog products. In some embodiments, the online system may instruct the client user device to present (e.g., via an ordering interface) a select all option. The user client device presents the recommendation(s) of catalog products associated with a received list of recommended catalog products. In some embodiments, the user may select different sources to see recommendations of catalog products (that correspond to the item descriptors) for those sources. The user may add some or all of the recommended catalog products to a shopping list, and finalize the order with the online system.

### ADDITIONAL CONSIDERATIONS

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a non-transitory computer readable medium, comprising:
receiving, in association with a user, a list that includes one or more item descriptors, wherein each item descriptor corresponds to one or more catalog products stored in a catalog database that includes a plurality of catalog products, each of the plurality of catalog products available from one or more sources;
retrieving linking data for the user, wherein the linking data describes historical interactions by the user with one or more of the plurality of the catalog products;
for at least one of the item descriptors in the list, applying an item association model to the linking data to generate a score for each of a set of candidate catalog products, wherein the item association model comprises a machine learning model that was trained by:
accessing a set of training examples including linking data for different users,
applying the item association model to the set of training examples to generate a training output corresponding to a predicted training set of catalog products and associated training scores,
back-propagating one or more error terms obtained from one or more loss functions to update a set of parameters of the item association model, and one or more of the error terms are based on a difference between a label applied to a test interaction of the set of training examples and the predicted training set of catalog products and associated training scores, and
stopping the back-propagation after the one or more loss functions satisfy one or more criteria;
building a list of recommended catalog products for the user by, for each of the at least one of the item descriptors in the list, selecting one of the set of candidate catalog products based on the generated scores; and
providing the list of recommended catalog products to a user client device associated with the user, wherein providing the list of recommended catalog products to the user client device causes the user client device to display the list of recommended catalog products.

2. The method of claim 1, wherein applying the item association model to the linking data to generate the score for each of the set of candidate catalog products further comprises:
identifying one or more sets of ranked candidate catalog product-score pairs where each of the one or more sets corresponds to a different catalog product of the plurality of catalog products;
retrieving pricing information for each candidate catalog product of each of the one or more sets of ranked candidate catalog product-score pairs; and
retrieving availability information at the one or more sources for each candidate catalog item of each of the one or more sets of ranked candidate catalog product-score pairs;
wherein building the list of recommended catalog products for the user by, for each of the at least one of the item descriptors in the list, selecting one of the set of candidate catalog products based on the generated scores, comprises:
applying the one or more sets of ranked candidate catalog product-score pairs, the pricing information, and the availability information to a list recommendation model that outputs a plurality of lists of recommended catalog products, and
selecting the list of recommended catalog products from the plurality of lists of recommended catalog products, wherein the list of recommended catalog products is for a source of the one or more sources.

3. The method of claim 2, further comprising:
retrieving user data describing favorite sources of the user;
wherein building the list of recommended catalog products for the user by, for each of the at least one of the item descriptors in the list, selecting one of the set of candidate catalog products based on the generated scores, further comprises:
applying the user data to the list recommendation model to output the plurality of lists of recommended catalog products.

4. The method of claim 1, wherein providing the list of recommended catalog products to the user client device associated with the user comprises:
instructing an ordering interface of the user client device to display an option that, once selected, adds all of the list of recommended catalog products to a shopping list.

5. The method of claim 1, wherein receiving the list that includes the one or more item descriptors comprises:
instructing the user client device to capture an image of the list that includes the one or more item descriptors; and
responsive to receiving the image, performing text recognition to identify one or more text strings, where each text string corresponds to a different item descriptor of the one or more item descriptors.

6. The method of claim 1, wherein receiving the list that includes the one or more item descriptor comprises:
providing one or more recipes to the user client device, wherein each recipe is associated with a different list of item descriptors;
receiving, from the user client device, a recipe of the one or more recipes; and
extracting the list of the one or more item descriptors from the recipe.

7. The method of claim 1, wherein the list of one or more item descriptors was generated using a third party application on the user client device.

8. The method of claim 1, further comprising:
generating additional training examples using the list of recommended catalog products and a purchase by the user of a catalog product on the list responsive to the list of recommended catalog products being displayed on the user client device; and
retraining the item association model based in part on the additional training examples.

9. A computer program product comprising a non-transitory computer readable storage medium having instructions encoded thereon that, when executed by a processor of a computer system, cause the computer system to:
receive, in association with a user, a list that includes one or more item descriptors, wherein each item descriptor corresponds to one or more catalog products stored in a catalog database that includes a plurality of catalog products, each of the plurality of catalog products available from one or more sources;
retrieve linking data for the user, wherein the linking data describes historical interactions by the user with one or more of the plurality of the catalog products;
for at least one of the item descriptors in the list, apply an item association model to the linking data to generate a score for each of a set of candidate catalog products, wherein the item association model comprises a machine learning model that was trained by:
accessing a set of training examples including linking data for different users,
applying the item association model to the set of training examples to generate a training output corresponding to a predicted training set of catalog products and associated training scores,
back-propagating one or more error terms obtained from one or more loss functions to update a set of parameters of the item association model, and one or more of the error terms are based on a difference between a label applied to a test interaction of the set of training examples and the predicted training set of catalog products and associated training scores, and
stopping the back-propagation after the one or more loss functions satisfy one or more criteria;
build a list of recommended catalog products for the user by, for each of the at least one of the item descriptors in the list, selecting one of the set of candidate catalog products based on the generated scores; and
provide the list of recommended catalog products to a user client device associated with the user, wherein providing the list of recommended catalog products to the user client device causes the user client device to display the list of recommended catalog products.

10. The computer program product of claim 9, wherein applying the item association model to the linking data to generate the score for each of the set of candidate catalog products further comprises:
identifying one or more sets of ranked candidate catalog product-score pairs where each of the one or more sets corresponds to a different catalog product of the plurality of catalog products;
retrieving pricing information for each candidate catalog product of each of the one or more sets of ranked candidate catalog product-score pairs; and
retrieving availability information at the one or more sources for each candidate catalog item of each of the one or more sets of ranked candidate catalog product-score pairs;
wherein building the list of recommended catalog products for the user by, for each of the at least one of the item descriptors in the list, selecting one of the set of candidate catalog products based on the generated scores, comprises:
applying the one or more sets of ranked candidate catalog product-score pairs, the pricing information, and the availability information to a list recommendation model that outputs a plurality of lists of recommended catalog products, and
selecting the list of recommended catalog products from the plurality of lists of recommended catalog products, wherein the list of recommended catalog products is for a source of the one or more sources.

11. The computer program product of claim 9, further comprising encoded instructions that when executed cause the computer system to perform steps comprising:
retrieving user data describing favorite sources of the user;
wherein building the list of recommended catalog products for the user by, for each of the at least one of the item descriptors in the list, selecting one of the set of candidate catalog products based on the generated scores, further comprises:
applying the user data to the list recommendation model to output the plurality of lists of recommended catalog products.

12. The computer program product of claim 9, wherein providing the list of recommended catalog products to the user client device associated with the user comprises:
instructing an ordering interface of the user client device to display an option that, once selected, adds all of the list of recommended catalog products to a shopping list.

13. The computer program product of claim 9, wherein receiving the list that includes the one or more item descriptors comprises:
instructing the user client device to capture an image of the list that includes the one or more item descriptors; and
responsive to receiving the image, performing text recognition to identify one or more text strings, where each text string corresponds to a different item descriptor of the one or more item descriptors.

14. The computer program product of claim 9, wherein receiving the list that includes the one or more item descriptor comprises:
providing one or more recipes to the user client device, wherein each recipe is associated with a different list of item descriptors;
receiving, from the user client device, a recipe of the one or more recipes; and
extracting the list of the one or more item descriptors from the recipe.

15. The computer program product of claim 9, wherein the list of one or more item descriptors was generated using a third party application on the user client device.

16. The computer program product of claim 9, further comprising encoded instructions that when executed cause the computer system to perform steps comprising:
generating additional training examples using the list of recommended catalog products and a purchase by the user of a catalog product on the list responsive to the list of recommended catalog products being displayed on the user client device; and
retraining the item association model based in part on the additional training examples.

17. A computer system comprising:
a processor; and
a non-transitory computer readable storage medium having instructions encoded thereon that, when executed by the processor, cause the computer system to perform steps comprising:
receiving, in association with a user, a list that includes one or more item descriptors, wherein each item descriptor corresponds to one or more catalog products stored in a catalog database that includes a plurality of catalog products, each of the plurality of catalog products available from one or more sources,
retrieving linking data for the user, wherein the linking data describes historical interactions by the user with one or more of the plurality of the catalog products,
for at least one of the item descriptors in the list, applying an item association model to the linking data to generate a score for each of a set of candidate catalog products, wherein the item association model comprises a machine learning model that was trained by:
accessing a set of training examples including linking data for different users,
applying the item association model to the set of training examples to generate a training output corresponding to a predicted training set of catalog products and associated training scores,
back-propagating one or more error terms obtained from one or more loss functions to update a set of parameters of the item association model, and one or more of the error terms are based on a difference between a label applied to a test interaction of the set of training examples and the predicted training set of catalog products and associated training scores, and
stopping the back-propagation after the one or more loss functions satisfy one or more criteria,
building a list of recommended catalog products for the user by, for each of the at least one of the item descriptors in the list, selecting one of the set of candidate catalog products based on the generated scores, and
providing the list of recommended catalog products to a user client device associated with the user, wherein providing the list of recommended catalog products to the user client device causes the user client device to display the list of recommended catalog products.

18. The computer system of claim 17, wherein applying the item association model to the linking data to generate the score for each of the set of candidate catalog products further comprises:
identifying one or more sets of ranked candidate catalog product-score pairs where each of the one or more sets corresponds to a different catalog product of the plurality of catalog products;
retrieving pricing information for each candidate catalog product of each of the one or more sets of ranked candidate catalog product-score pairs; and
retrieving availability information at the one or more sources for each candidate catalog item of each of the one or more sets of ranked candidate catalog product-score pairs;
wherein building the list of recommended catalog products for the user by, for each of the at least one of the item descriptors in the list, selecting one of the set of candidate catalog products based on the generated scores, comprises:
applying the one or more sets of ranked candidate catalog product-score pairs, the pricing information, and the availability information to a list recommendation model that outputs a plurality of lists of recommended catalog products, and
selecting the list of recommended catalog products from the plurality of lists of recommended catalog products, wherein the list of recommended catalog products is for a source of the one or more sources.

19. The computer system of claim 17, wherein receiving the list that includes the one or more item descriptors comprises:
instructing the user client device to capture an image of the list that includes the one or more item descriptors; and
responsive to receiving the image, performing text recognition to identify one or more text strings, where each text string corresponds to a different item descriptor of the one or more item descriptors.

20. The computer system of claim 17, further comprising encoded instructions that when executed cause the computer system to perform steps comprising:
generating additional training examples using the list of recommended catalog products and a purchase by the user of a catalog product on the list responsive to the list of recommended catalog products being displayed on the user client device; and
retraining the item association model based in part on the additional training examples.
